(19) United States
(12) Patent Application Publication
(10) Pub. No.: US 2008/0024974 A1
(43) Pub. Date: Jan. 31, 2008

(54) CAPACITY-ADJUSTABLE CARD DISPENSER

(75) Inventor: Hung-Yi Chang, Chilung City (TW)

Correspondence Address: INTERNATIONAL CURRENCY TECHNOLOGIES CORPORATION, 2F-4. NO. 148, SEC. 4, CHUNG HSIAN EAST ROAD, TAIPEI, omitted

(73) Assignee: INTERNATIONAL CURRENCY TECHNOLOGIES CORPORATION, Taipei City (TW)

(21) Appl. No.: 11/459,937

(22) Filed: Jul. 26, 2006

(51) Int. Cl. G06F 1/16

(52) U.S. Cl. 361/686

(57) ABSTRACT

A capacity-adjustable card dispenser is disclosed to include a housing having an accommodation chamber for holding a stack of cards for dispensing, a plurality of expansion modules attachable to one another in a stack and attachable to the housing to expand the accommodation chamber, and male and female coupling devices respectively provided at the housing and the expansion modules for enabling the expansion modules to be detachably secured to one another in a stack and detachably secured to the housing.

### BACKGROUND OF THE INVENTION

1. Field of the Invention

The present invention relates to automatic vending machines and more specifically, to a capacity-adjustable card dispenser for automatic vending machine that can selectively be attached with expansion modules to increase the card accommodation capacity.

2. Description of the Related Art

Following fast development of information technology, non-shop business has become popular. Nowadays, various automatic vending machines are used everywhere to sell different products without servicemen. These automatic vending machines bring convenience to consumers and create new marketing routes for the suppliers.

Further, an automatic vending machine has an exchanger on the inside for providing different products to the user after having received a bill. Following fast development of high technology, various advanced automatic vending machines such as ticket venders, bill exchangers, coin exchangers, and etc., have bee continuously created and appeared in different public places or street corners. Different sizes of bill exchangers or card/ticket vending machines are respectively equipped with a different size of bill or card dispenser. Further, different specifications of bill or card dispensers may be prepared to fit different sizes of bills or cards. Preparing different specifications of bill or card dispensers in order to fit different sizes of bills or cards greatly increases the material and manufacturing cost as well the inventory cost. Further, conventional card dispensers are not adjustable to change the dispensing capacity. Therefore, different sizes of card dispensers may be used for different dispensing requirements. However, making card dispensers in different sizes relatively increases the manufacturing, inventory and packing cost.

Therefore, it is desirable to provide a card dispenser that is expansible to increase the card accommodation capacity.

### SUMMARY OF THE INVENTION

The present invention has been accomplished under the circumstances in view. It is the main object of the present invention to provide a card dispenser, which is expansible to increase the card dispensing capacity. It is another object of the present invention to provide a capacity-adjustable card dispenser, which is modularized for easy fabrication. To achieve these and other objects of the present invention, the capacity-adjustable card dispenser comprises a housing, which has an accommodation chamber adapted to hold a stack of cards for dispensing, a plurality of expansion modules attachable to one another in a stack and attachable to the housing to expand the accommodation chamber, and coupling means for enabling the expansion modules to be coupled to one another and selectively coupled to the housing.

### BRIEF DESCRIPTION OF THE DRAWINGS

FIG. 1 is an exploded view of the capacity-adjustable card dispenser according to the present invention.

FIG. 1A is an enlarged view of a part of the expansion module, showing the structure of the female coupling means according to the present invention.

FIG. 1B is an enlarged view of a part of the housing, showing the structure of the male coupling means according to the present invention.

FIG. 1C is an enlarged view of a part of the expansion module, showing the arrangement of the positioning structure according to the present invention.

FIG. 1D is an enlarged view of a part of the housing, showing the structure of the locating block according to the present invention.

FIG. 2 is a perspective assembly view of a part of the present invention, showing one expansion module fastened to the hosing according to the present invention.

FIG. 2A is an enlarged view of part A of FIG. 2.

FIG. 2B is an enlarged view of part B of FIG. 2.

FIG. 3 is a perspective assembly view showing the installation of one expansion module in the housing according to the present invention.

FIG. 4 is an exploded view of two expansion modules according to the present invention.

FIG. 4A is an enlarged view of a part of FIG. 4.

FIG. 5 shows two expansion modules fastened together according to the present invention.

FIG. 5A is an enlarged view of a part of FIG. 5.

### DETAILED DESCRIPTION OF THE PREFERRED EMBODIMENT

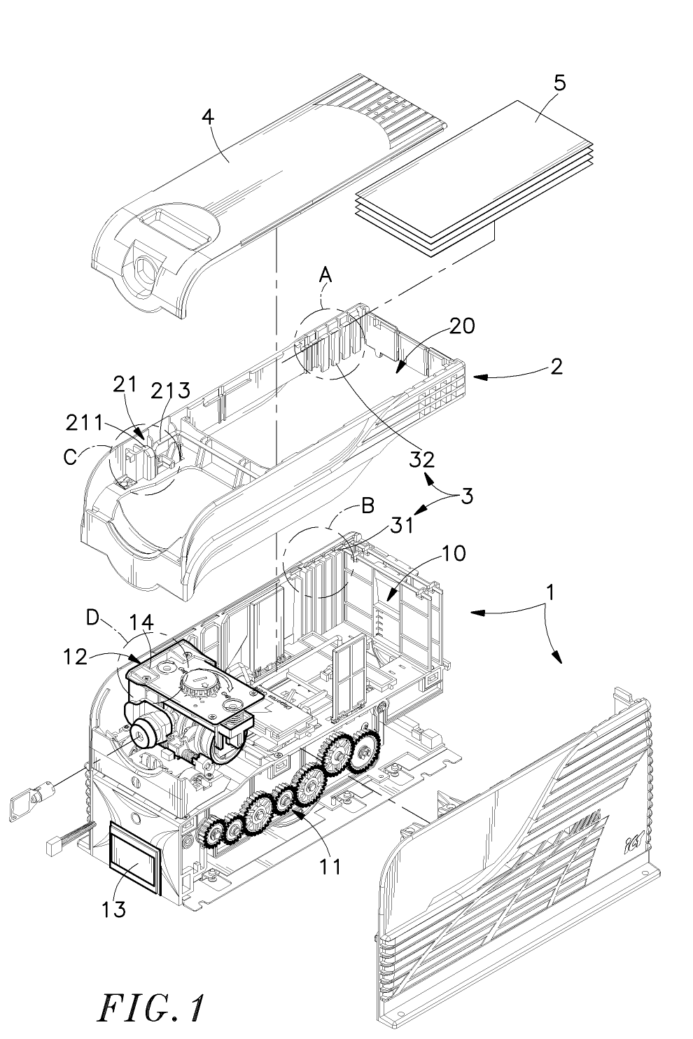

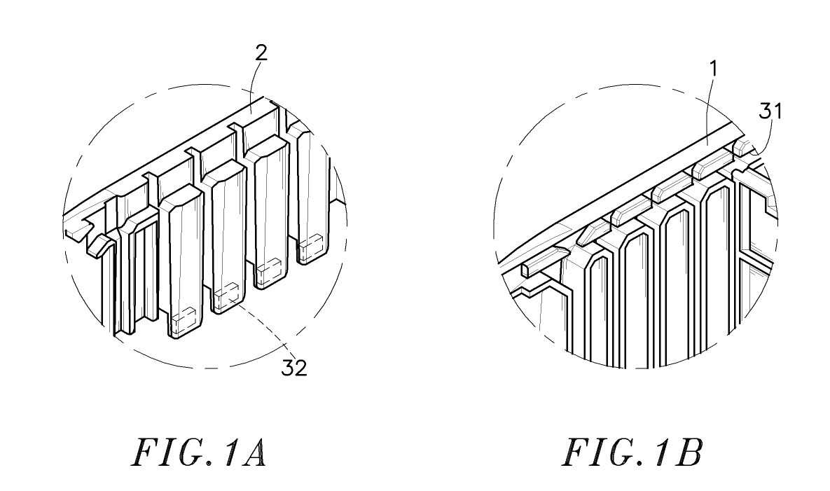

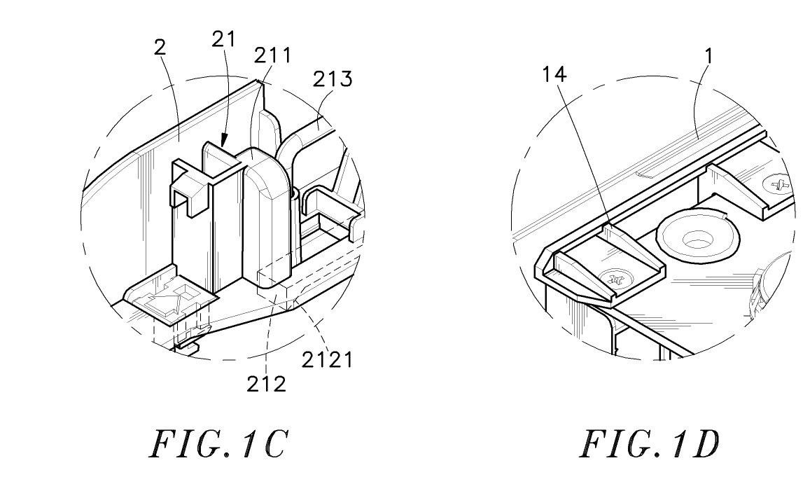

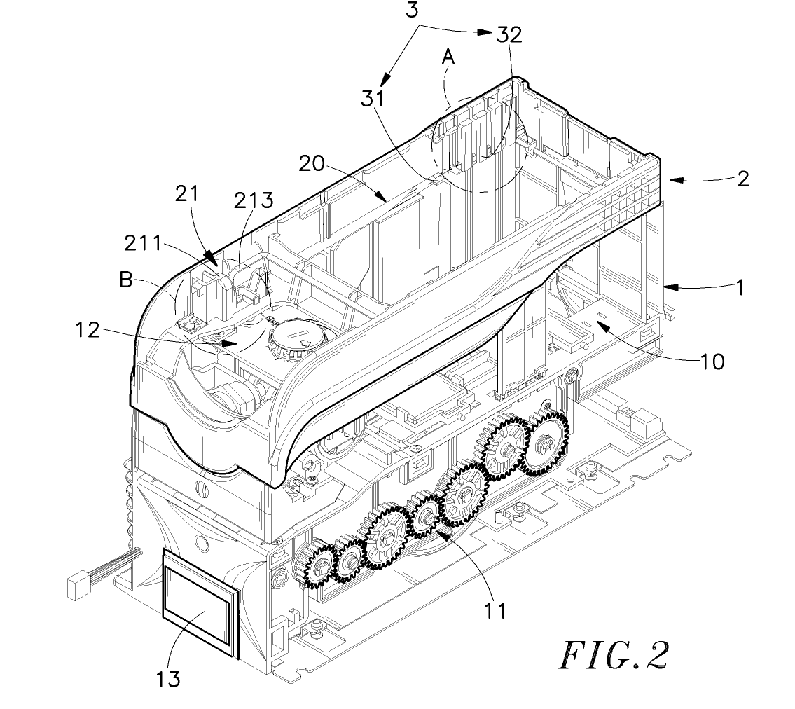

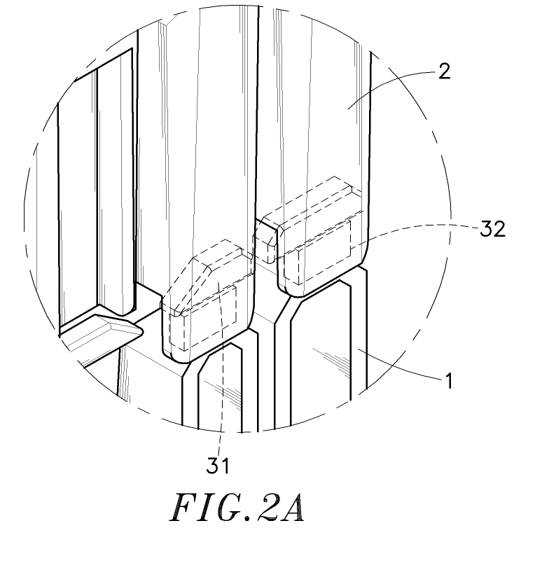

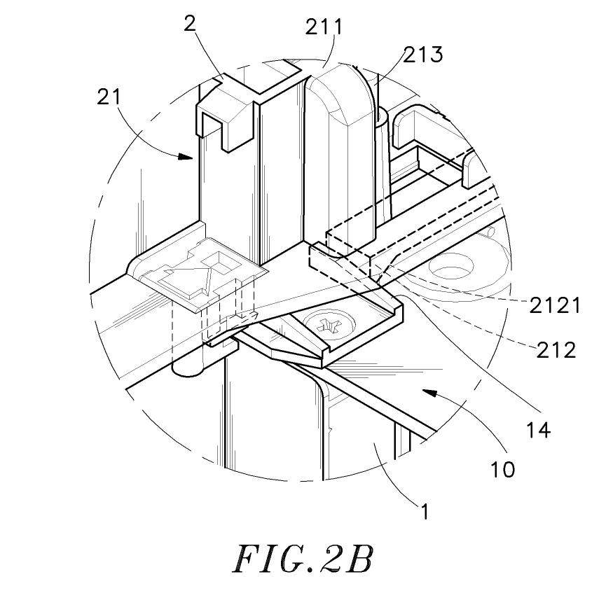

Referring to FIGS. 1 and 2, a capacity-adjustable card dispenser in accordance with the present invention is shown comprising a housing 1 and a plurality of expansion modules 2.

The housing 1 has an accommodation chamber 10 adapted to accommodate cards (or tickets or notes) 5, a conveying unit 11 provided at the bottom side of the accommodation chamber 10 and adapted to deliver the accommodated cards 5 to the outside of the housing 1 individually, a gap adjustment device 12 adapted to adjust a gap of a card output path through which every accommodated card 5 is delivered by the conveying unit 11 to the outside of the housing 1, a counter 13 adapted to count the number of the cards 5 been dispensed and to indicate the number.

The expansion modules 2 are hollow members, each having an accommodation open chamber 20 adapted to receive cards 5.

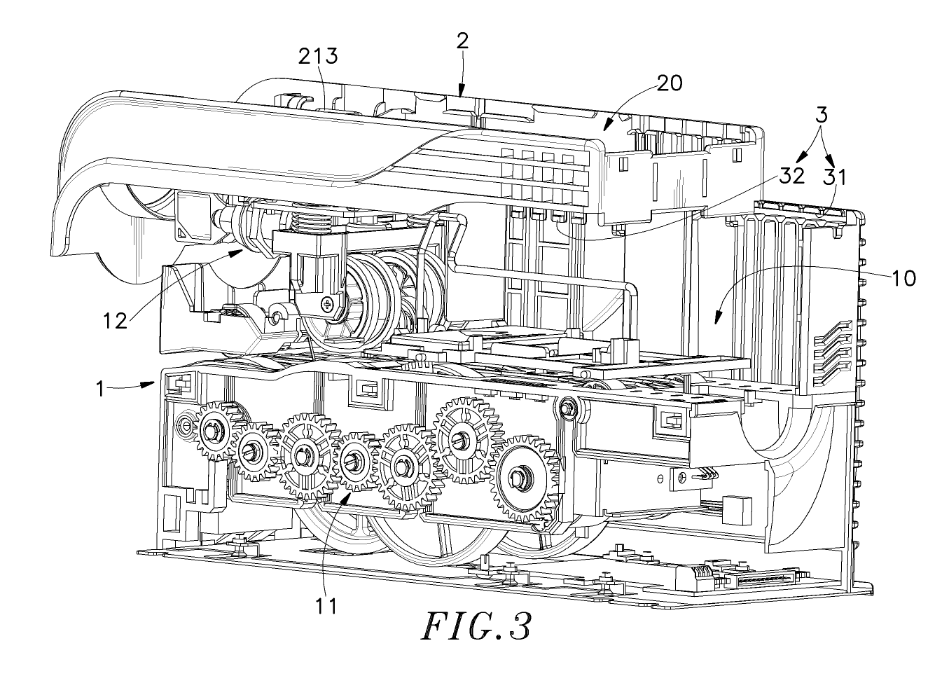

Referring to FIGS. 1˜5, female coupling means 31 is respectively provided at the housing 1 and the top side of each expansion module 2 and male coupling means 32 is respectively provided at the bottom side of each expansion module 2 such that one expansion module 2 or a number of expansion modules 2 can be coupled to the housing 1 in a stack by securing the respective female coupling means 31 and the respective male coupling means 32, keeping the accommodation open chamber 20 of each expansion module 2 in vertical alignment with the accommodation chamber 10 of the housing 10 (see FIGS. 2, 2A, 3, 4 and 5) to accommodate a big number of cards 5. According to this embodiment, the female coupling means 31 is comprised of a plurality of coupling grooves, and the male coupling means 32 is comprised of a plurality of coupling blocks for engaging the coupling grooves of the female coupling means 31 (see FIGS. 1A and 1B). The female coupling means 31 and the male coupling means 32 constitute a coupling structure 3.

Further, if a cover plate 4 is provided for covering the housing 1 or the attached expansion module or modules 2 to prevent falling of the accommodated cards 5 and to prohibit people from stealing the accommodated cards 5 (see FIG. 1).

As stated above, the conveying unit 11 is provided at the bottom side of the accommodation chamber 10 and adapted to deliver the accommodated cards 5 to the outside of the housing 1 individually; the gap adjustment device 12 is adapted to adjust the gap of the card output path subject to the thickness of the cards 5 so that the cards 5 can be delivered by the conveying unit 11 through the card output path individually to the outside of the housing 1; the counter 13 is adapted to count the number of cards 5 been dispensed and to indicate the counted number so that the worker immediately knows the number of rest cards 5 in the accommodation chamber 10 when removing the housing 1 from the auto vending machine for a replacement. Because the conveying unit 11, the gap adjustment device 12 and the counter 13 are of the known art and not within the scope of the claims of the present invention, no further detailed description in this regard is necessary.

In the aforesaid embodiment, the female coupling means 31 is respectively provided at the top side of the housing 1 and the top side of each expansion module 2 and the male coupling means 32 is respectively provided at the bottom side of each expansion module 2. Alternatively, the male coupling means 32 can be respectively provided at the top side of the housing 1 and the top side of each expansion module 2 and the male coupling means 31 can be respectively provided at the bottom side of each expansion module 2, achieving the same effect.

Referring to FIGS. 1, 4 and 5, when multiple, for example, two expansion modules 2 are attached to the housing 1 in a stack, the expansion modules 2 are locked by locking means. According to this embodiment, each expansion module 2 has a positioning structure 21 in the accommodation open chamber 20. The positioning structure 21 comprises two locating blocks 211 vertically symmetrically disposed at two sides inside the accommodation open chamber 20, two spring-supported movable locking bars 212 respectively suspending below the locating blocks 211, and two handles 213 respectively connected to the locking bars 212. The locking bars 212 each have a beveled guide face 2121. Further, two locating blocks 14 are bilaterally provided inside the accommodation chamber 10 of the housing 1 corresponding to the locating blocks 211 of each expansion module 2.

Referring to FIGS. 1, 1C, 1D, 2 and 2B, when attaching one expansion module 2 to the housing 1, the male coupling means 32 of the expansion module 2 is coupled to the female coupling means 31 of the housing 1. At this time, the beveled guide faces 2121 of the locking bars 212 of the expansion module 2 are respectively moved over the locating blocks 14 of the housing 1 into engagement with the locating blocks 14, and therefore the expansion module 2 is locked to the housing 1. When dismounting the expansion module 2, pull the handles 213 to disengage the locking bars 212 from the locating blocks 14 and then remove the expansion module 2 from the housing 1.

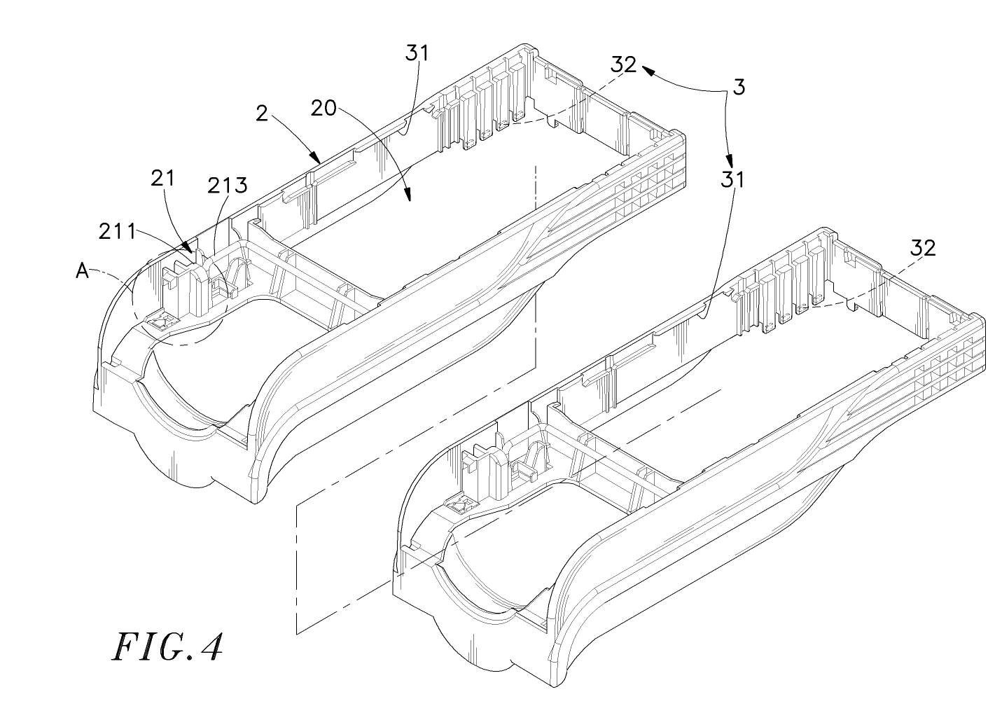

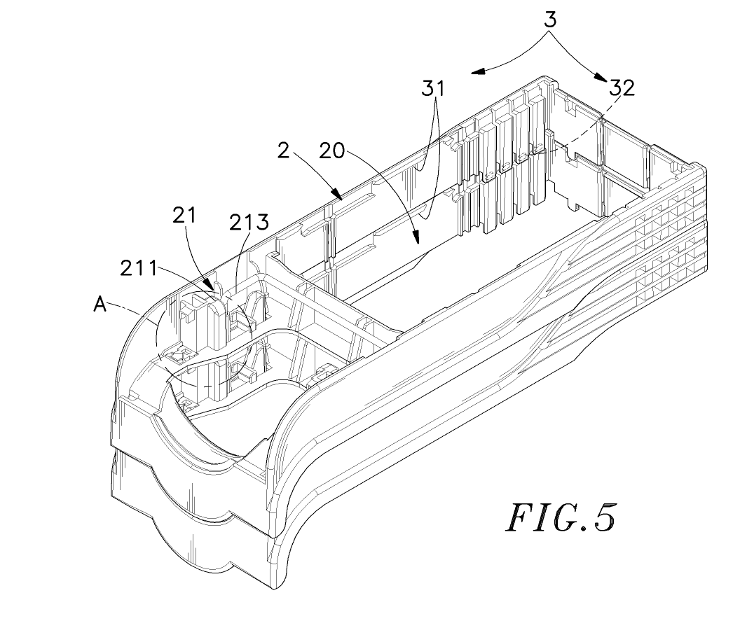

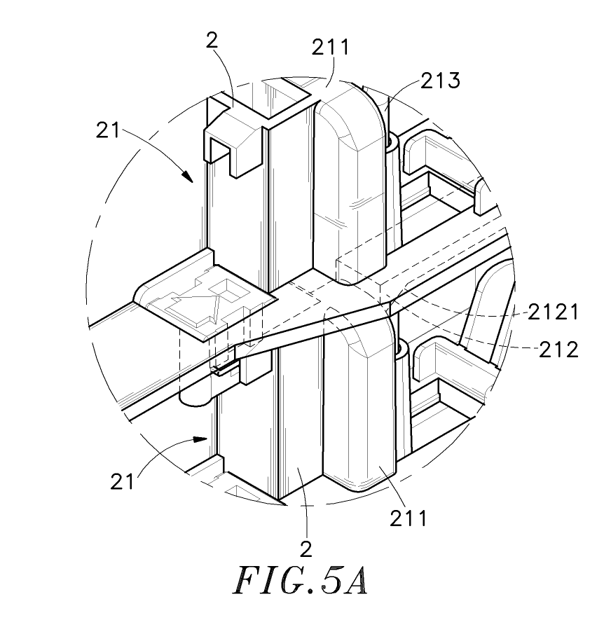

Referring to FIGS. 4, 4A, 5 and 5A, when attaching two expansion modules 2 in a stack, the male coupling means 32 of one expansion module 2 is coupled to the female coupling means 31 of the other expansion module 2. At this time, the beveled guide faces 2121 of the locking bars 212 of one expansion module 2 are respectively moved over the locating blocks 211 of the other expansion module 2 into engagement with the locating blocks 211 of the other expansion module 2, and therefore the two expansion modules 2 are locked. When dismounting the expansion modules 2, pull the handles 213 of one expansion modules 2 to disengage the associating locking bars 212 from the locating blocks 211 of the other expansion module 2 and then detach the two expansion modules 2.

As indicated above, the housing 1 and the expansion modules 2 are modularized for easy fabrication. The user can attach one or a number of expansion modules 2 to the housing 1 subject to the amount of the cards 5 to be dispensed, i.e., the capacity of the card dispenser is conveniently adjustable. Further, the gap adjustment device 12 of the card dispenser allows the user to adjust the gap of the card output path subject to the thickness of the cards 5 so that the cards 5 can be delivered by the conveying unit 11 through the card output path individually to the outside of the housing 1 and the card dispenser can fit any of a variety of cards 5 such as play member cards, game cards, telephone cards, bus cards, valuable cards, non-valuable cards, etc.

A prototype of capacity-adjustable card dispenser has been constructed with the features of FIGS. 1˜5. The capacity-adjustable card dispenser functions smoothly to provide all of the features disclosed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A capacity-adjustable card dispenser comprising:
a housing, said housing having an accommodation chamber adapted to hold a stack of cards for dispensing;
a plurality of expansion modules attachable to one another in a stack and attachable to said housing for accommodating cards above said accommodation chamber, said expansion modules each comprising an accommodation open chamber corresponding to the accommodation chamber of said housing for holding a stack of cards accommodated in the accommodation chamber of said housing; and
coupling means respectively provided in said housing and said expansion modules for enabling said expansion modules to be coupled together in a stack and selectively coupled to said housing.

2. The capacity-adjustable card dispenser as claimed in claim 1, wherein said housing comprises conveying means provided at a bottom side of said accommodation chamber and adapted to deliver said accommodated cards individually out of said accommodation chamber.

3. The capacity-adjustable card dispenser as claimed in claim 1, wherein said housing comprises a card output path for guiding said accommodated cards out of said accommodation chamber, and gap adjustment means adapted to adjust a gap of the card output path through which every accommodated card is delivered by said conveying means out of said accommodation chamber.

4. The capacity-adjustable card dispenser as claimed in claim 1, wherein said housing comprises counter adapted to count and record the number of cards been delivered out of said accommodation chamber.

5. The capacity-adjustable card dispenser as claimed in claim 1, wherein said coupling means comprises a plurality of male coupling devices respectively provided at said housing and a top side of each of said expansion module and a plurality of female coupling devices respectively provided at a top side of each of said expansion modules and connectable to said male coupling devices.

6. The capacity-adjustable card dispenser as claimed in claim 1, wherein said coupling means comprises a plurality of female coupling devices respectively provided at said housing and a top side of each of said expansion module and a plurality of male coupling devices respectively provided at a top side of each of said expansion modules and connectable to said female coupling devices.

7. The capacity-adjustable card dispenser as claimed in claim 1, wherein said coupling means is a hook joint.

8. The capacity-adjustable card dispenser as claimed in claim 1, further comprising cover plate for fastening to said housing to close said accommodation chamber when said housing is not attached with said expansion modules, and for fastening to one of said expansion module to close the associating accommodation open chamber when at least one of said expansion module is fastened to said housing.

9. The capacity-adjustable card dispenser as claimed in claim 1, further comprising positioning means adapted to lock at least one of said expansion modules to said housing, said positioning means comprising a plurality of locating blocks provided inside said housing and in each of said expansion module, and a plurality of spring-supported movable locking bars respectively provided in said expansion modules for engaging said locating blocks.

10. The capacity-adjustable card dispenser as claimed in claim 9, wherein said positioning means further comprises a plurality of handles respectively provided inside said expansion modules and respectively coupled to the spring-supported movable locking bars of the respective expansion modules for moving the respective spring-supported movable locking bars from said locating blocks.

11. The capacity-adjustable card dispenser as claimed in claim 9, wherein said locking bars each have a beveled guide face.
